(19) United States
(12) Patent Application Publication
(10) Pub. No.: US 2004/0251210 A1
(43) Pub. Date: Dec. 16, 2004

(54) Water filter control unit

(75) Inventors: Karl Fritze, Denmark Township, MN (US); David M. Botts, Minnetrista, MN (US)

Correspondence Address: Patterson, Thuente, Skaar & Christensen, P.A., 4800 IDS Center, 80 South 8th Street, Minneapolis, MN, 55402-2100, US

(73) Assignee: PentaPure Incorporated

(21) Appl. No.: 10/889,826

(22) Filed: Jul. 13, 2004

Related U.S. Application Data
(63) Continuation of application No. 10/445,372, filed on May 23, 2003.
(60) Provisional application No. 60/383,187, filed on May 23, 2002.

(51) Int. Cl. B01D 27/02

(52) U.S. Cl. 210/746; 210/282

(57) ABSTRACT

A water filter assembly allowing for uniform placement in refrigerators at the point of refrigerator manufacture, includes a self-contained unit, including a filter component, inlet and outlet connections, and water storage means all housed in one unit for placement, in its entirety, in the refrigerator during manufacture thereof with only a single point of inlet coupling to a refrigeration system of the refrigerator, the single point of coupling being to an internal refrigerator water supply. A method for uniform placement of a water filter assembly in refrigerators at the point of refrigerator manufacture is further included.

### RELATED APPLICATIONS

The present application is a continuation of copending U.S. patent application Ser. No. 10/445,372 to Fritze et al., filed on May 23, 2003, entitled “Water Filter Assembly,” which claims priority to U.S. Provisional Application 60/383,187, filed May 23, 2002, both of which are incorporated herein in their entirety by reference.

### FIELD OF THE INVENTION

The present invention relates generally to the field of water filtration systems mounted in a refrigerator. More specifically, the present invention relates to a self-contained water filtration apparatus adapted for quick and leak-free installation in a refrigerator.

### BACKGROUND OF THE INVENTION

Water filtration apparatuses are well known in the art. The necessity of water filtration for domestic use is increasing as population densities increase. Many municipal water supplies are contaminated with industrial and domestic pollutants that can adversely affect test or even render the water nonpotable. Further, in many rural areas, groundwater contains materials such as minerals giving the water an unpleasant appearance, taste and/or odor.

Many portable filtration apparatuses such as U.S. Pat. No. 3,950,253 to Stern exist. The '253 apparatus is designed to be portable and is commercially used mainly on countertops. This type of system requires the user to continually refill the apparatus as the water reservoir only holds a finite amount of water and is not connected directly to a water supply.

Refrigerator mounted filter systems connected directly to a water supply exist. For example, Whirlpool® uses water filtration systems in their refrigerators. These systems can be as simple as individual filters placed on a water line, wherever the manufacturer can find space for them. This type of system is cumbersome for manufacturers to install. It requires water lines and components to be placed piecemeal throughput the refrigerator. Further, the components of the apparatus (i.e. filter, water reservoir, inlet/outlet valves) are fitted separately and in different locations throughout the refrigerator resulting in longer installations and an increased number of potential leak points.

These piecemeal systems must be assembled differently for each model and size of refrigerator. A self-contained unit that could be placed in a uniform position in any refrigerator would greatly improve upon the current filtration systems.

### SUMMARY OF THE INVENTION

In one aspect, the water filter assembly of the present invention is a self-contained unit, allowing for uniform placement in appliances, most typically refrigerators, at the point of manufacture. The water filter assembly of the present invention includes a filter component, inlet and outlet connections, and water storage means all housed in one unit. This unit can then be placed, in its entirety, in the refrigerator during manufacture.

The filter component may have multiple filtering configurations. One embodiment of the filter could be designed to only use granular activated carbon as the filter media. Another embodiment could use a series of pretreatment and post treatment filter media in conjunction with the granular activated carbon. Still other embodiments could involve garnet, anthracite, greensand, birm, calcite, softening resins, ion exchange media, microfabric, polymers, ceramics, zeolyte, rhyolite or any other suitable filter media.

The inlet portion is in fluid communication with the refrigerator's water supply connection. The outlet portion may contain one or more outlet routes, one outlet may deliver drinking water, and another may supply water to an icemaker. The water filter assembly may contain a distribution manifold having valve controls to divert water to a particular outlet.

The water filter assembly may also include a flow sensor coupled to sensor electronics that measure flow.

The water storage means may be a simple tank. It may also be a predetermined length of tubing that holds a predetermined volume of water. This tubing system may act as a heat exchange system, for chilling water prior to dispensing.

In a further aspect, the present invention is a water filter assembly allowing for uniform placement in refrigerators at the point of refrigerator manufacture is a self-contained unit, including a filter component, inlet and outlet connections, and water storage means all housed in one unit for placement, in its entirety, in the refrigerator during manufacture thereof with only a single point of inlet coupling to a refrigeration system of the refrigerator, the single point of coupling being to a refrigerator's water supply connection. The present invention is further a method for uniform placement of a water filter assembly in refrigerators at the point of refrigerator manufacture.

In one embodiment, the present invention is a water filter assembly that is easily placed within a refrigerator. The water filter assembly comprises a support structure containing components such as a filter component, inlet and outlet connections and a water storage vessel, all components in fluid communication with one another.

In another embodiment, the present invention is a method for assembling a self-contained water filter assembly designed for uniform placement in a refrigerator. The water filter assembly typically comprises a filter component, inlet and outlet connections and a water storage vessel. The water filter assembly is designed to be installed as a single unit within the refrigerator.

In an additional aspect, the invention pertains to a filtration system comprising a manifold, a filter attached to the manifold and a control system. The control system disables the filtration system if a selected criterion is outside of acceptable levels.

In another aspect, the invention pertains to a method for controlling a water filtration system in which the method comprises disabling the filtration system if a selected criterion is outside of acceptable levels.

Furthermore, the invention pertains to a filtration system comprising a sensor, a manifold, and a replaceable filter element connected of the manifold. The filter element comprises a bar code indicating the date of manufacture and wherein the sensor reads the bar code to give the date of manufacture from the filter.

In addition, the invention pertains to a method for evaluating a filter cartridge attached to a filtration system comprising a control system. The method comprises using the control system of the filtration system to evaluate filter life based on the manufacture date.

### BRIEF DESCRIPTION OF THE DRAWINGS

FIG. 1 is a schematic of an embodiment of the water filter assembly of the present invention;

FIG. 2 is a schematic representation of the water filter assembly of FIG. 1.

FIG. 3 is a schematic representation of an embodiment of a water filter assembly.

FIG. 4 is a schematic representation of an alternate embodiment having a plurality of cascaded filter elements.

FIG. 5 is a schematic representation of an embodiment of a water filter assembly.

FIG. 6 is a schematic representation of an embodiment of a water filter assembly.

FIG. 7 is a schematic representation of an embodiment of a water filter assembly.

FIG. 8 is a schematic representation of an embodiment of a water filter assembly.

FIG. 9 is a schematic representation of an embodiment of a water filter assembly.

FIG. 10 is a schematic representation of an embodiment of a water filter assembly.

FIG. 11 is a schematic representation of an embodiment of a water filter assembly.

FIG. 12 is a schematic representation of an embodiment of a water filter assembly.

FIG. 13 is a schematic representation of an embodiment of a water filter assembly.

FIG. 14 is a schematic representation of an embodiment of a water filter assembly.

FIG. 15 is a schematic representation of an embodiment of a water filter assembly.

### DETAILED DESCRIPTION OF THE DRAWINGS

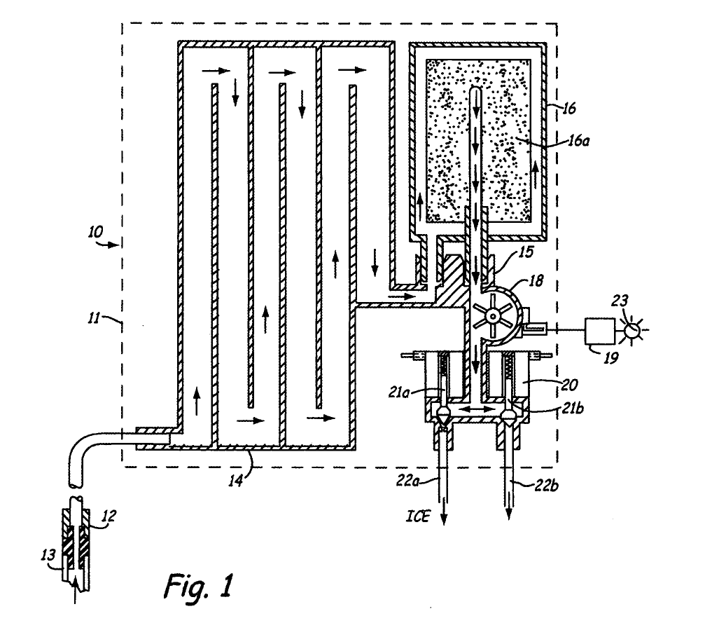

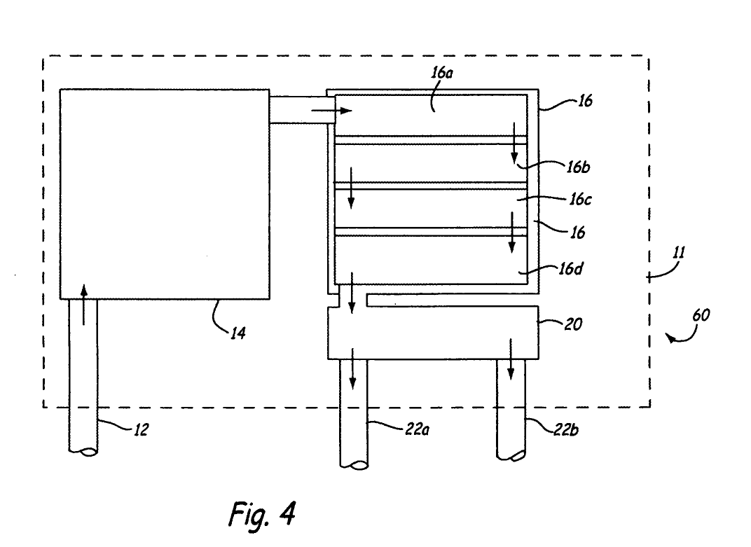

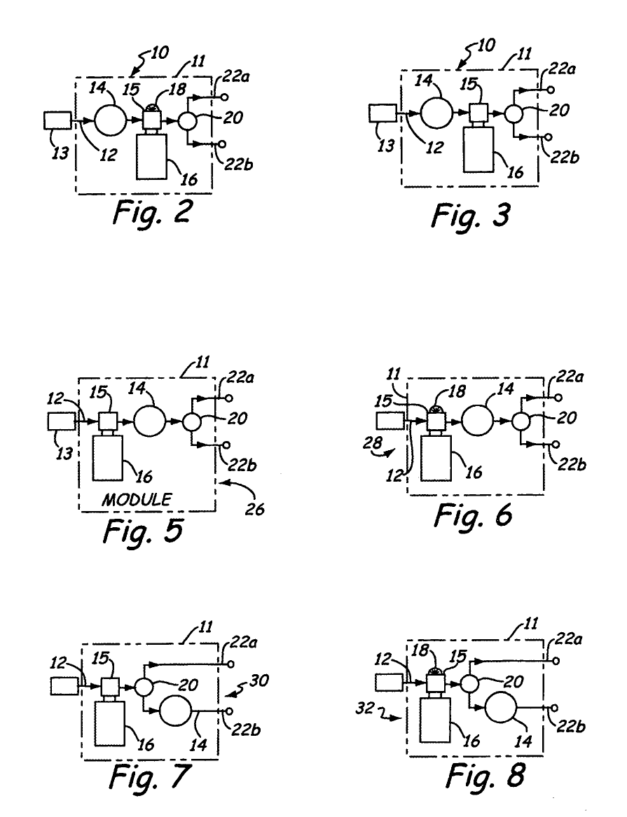

FIGS. 1 and 2 depict an embodiment of the water filter assembly 10. FIG. 2 is a schematic representation of assembly 10 shown in more detail in FIG. 1. Water filter assembly 10 comprises a support structure 11 onto which other components are assembled. Support structure 11 can be a housing, a rigid frame, or a flexible interconnection. Support structure 11 can provide for convenient attachment of a water filter assemble 10 into an appliance such as a refrigerator or the like. A housing can comprise a fully closed, box style assembly, an open frame assembly or the like while generally providing access for the replacement of spent, damaged or broken components. Other support structure 11 designs similarly maintain other components of water filter assembly 10 together as a unit. Support structure 11 can include a mounting surface for coupling the water filter assembly 10 within a refrigerator.

Water filter assembly 10 further comprises a water inlet 12 that connects to a water supply 13. Water inlet 12 typically comprises a length of plastic tubing for example tubing constructed of polypropyle, polyethylene, nylon and other suitable polymers. Water inlet 12 is in fluid communication with a water storage means 14. The water storage means 14 may have many configurations typically serving as a heat exchanger for supplying chilled, filtered water upon request. Water storage means 14 may be a tank or tanks. Water storage means 14 may also be a length of tubing which may or may not be serpentine or coiled to increase tubing length thus increasing retention volume. Water storage means 14 may include baffles, as shown in FIG. 1, to reduce or eliminate any water flow dead spots. Water storage means 14 can be constructed of metals such as aluminum or steel as well as plastic polymers such as polypropylene, polyethylene, nylon and other suitable polymers. The water storage means 14 is in fluid communication with an inlet side of a filter manifold 15.

Filter manifold 15 is connected to a filter element 16. Filter manifold 15 and filter element 16 can be rotatably connectable as disclosed in U.S. Pat. No. 6,027,644 and U.S. patent application Ser. Nos. 09/618,686, 09/929,920, 10/196,340, 10/202,290 and 10/406,637 or the connection can be slidably insertable as disclosed in U.S. patent application Ser. No. 10/210,890, all of which are commonly assigned to the assignee of the current invention and are hereby incorporated by reference in their entirety. Filter manifold can be an integral part of water storage means 14 for instance via a molding process or may be directly attachable to the exterior of water storage means 14. The filter element 16 may include any one or a combination of the following filter media: granular activated carbon, block activated carbon, garnet, anthracite, greensand, birm, calcite, softening resins, perforated absolute membrane or microfabric sheet, spun blown, ion exchange resins, polymers, ceramics, zeolyte, rhyolite or any other suitable filter media. Filter manifold 15 may include a flow sensor 18 on either an inlet or outlet side of the filter manifold 15 or integrally molded within filter manifold 15. As shown in FIG. 3, water filter assembly 10 can be constructed without flow sensor 18.

In addition or alternative to flow sensor 18, water filter assembly 10 may comprise various other sensors such as conductivity/resistivity, pH and temperature. A suitable sensor could include a bar code sensor to interface with a bar coding supplied with filter element 16, such that certain information such as date of manufacture or flow capacities can be determined. Flow sensor 18 can be wired to an electronics unit 19 an external unit such as a component of the refrigerator. Electronics unit 19 can be integral to water filter assembly 10 or can be an external unit such as a component of the refrigerator. Typically, electronics unit 19 comprises a microprocessor capable of interfacing with flow sensor 18. Electronics unit 19 can include a variety of performance and troubleshooting programs utilizing flow information supplied by flow sensor 18. Examples of these programs could including total flow, replacement schedules and current system status. Display unit 23 can include a liquid crystal display or similar display capable of displaying text messages regarding system status. Alternatively, display unit 23 can include a light or variety of lights for indicating status or required service. Water filter assembly 10 can also include a distribution manifold 20 for directing filtered water to desired point of use such as a drinking water dispenser or an icemaker through a plurality of water outlets 22a, 22b which can be two or more outlets. Distribution manifold 20 can include a plurality of solenoid valves 21a, 21b which open and close based upon an input from the points of use. In alternative embodiments, distribution manifold 20 can include a single outlet with flow controlled by a single valve, such as a solenoid valve. In other embodiments, solenoid valves 21a, 21b may be wired to electronics unit 19 allowing for filter assembly 10 to be disabled if certain criteria, such as those monitored by flow sensor 18 such as total flow, water quality standards or filter life based on the manufacturing date, are outside acceptable levels.

An alternate water filter assembly 15 is depicted in FIG. 4. Water filter assembly 15 makes uses of a filter element 16 having a plurality of replaceable filter elements 16a-16d. The filter elements 16a-16d are physically aligned and fluidly coupled in cascade, so that water flow passes sequentially through filter elements 16a-16d. The media of filter elements 16a-16d may be selected from the list above, as desired. The filter elements 16a-16d may be replaced one at a time or all together, as desired, by sliding each filter element 16a-16d out of and into the filter element housing 16. Element 16b may comprise the activated carbon with a plurality of pre and post filtering elements 16a and 16c, 16d, as desired.

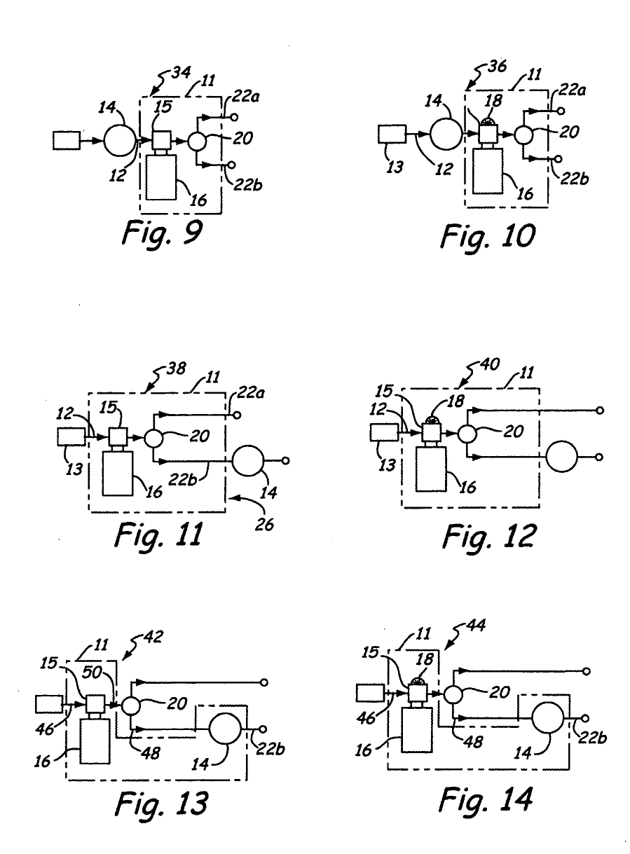

While FIGS. 1, 2, 3, and 4 depict convenient configurations of the assembly components, the components can be configured with alternative arrangements within the assembly. For example, FIGS. 5 and 6 depict alternative water filter assemblies 26 and 28 having different configurations of components. Each water filter assembly includes a support structure 11 and at least one water inlet 12 and outlets, such as outlets 22a, 22b. Water filter assembly 28 includes a sensor 18. FIGS. 7 and 8 depict alternative water filter assemblies 30 and 32 with a valve upstream from a storage tank. Each water filter assembly includes a support structure 11 and at least one water inlet 12 and outlets, such as outlets 22a, 22b. Water filter assembly 32 includes a sensor 18. FIGS. 9 and 10 depict alternative water filter assemblies 34 and 36 including an upstream storage tank that is not part of the assemblies. Each water filter assembly includes a support structure 11 and at least one water inlet 12 and outlets, such as outlets 22a, 22b. Water filter assembly 36 includes a sensor 18. FIGS. 11 and 12 depict alternative water filter assemblies 38 and 40 including a downstream storage tank that is not part of the assemblies. Each water filter assembly includes a support structure 11 and at least one water inlet 12 and outlets, such as outlets 22a, 22b. Water filter assembly 40 includes a sensor 18. FIGS. 13 and 14 depict alternative water filter assemblies 42 and 44. Water filter assemblies 42 and 44 include a valve that is not part of the assemblies and include a supply inlet 46 and a distribution inlet 48 as well as filtered outlet 50 and as well as outlet 22b. Water filter assembly 44 includes a sensor 18. Water filter assemblies 26, 28, 30, 32, 34, 36, 38, 40, 42 and 44 are representative of the types of modifications that can be made without departing from the spirit and scope of the present invention.

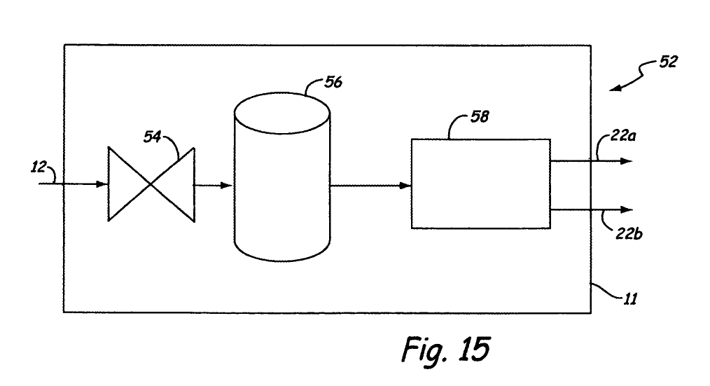

In FIG. 15, water filter assembly 52 includes a valve assembly 54 upstream of a filter assembly 56. From filter assembly 56, water flows to tank 58 into which outlets 22a, 22b are attached. Outlet 22a can be plumbed directly to an ice maker while outlet 22b can deliver filtered water to a drinking water dispenser or other points of use.

With respected to the embodiments shown and describe, additional configurations including multiple filter elements providing multiple filtering steps can be arranged in various sequential and non-sequential arrangements in the water filter assembly to achieve certain desired filtering levels such as the removal of chlorine, organics, total dissolve solids and the like.

In practice, the water filter assemblies of the present invention are assembled and tested prior to installation by the refrigerator manufacturer. When received by the manufacturer, water filter assembly 10 is positioned and support structure 11 is fixedly attached to the refrigerator. Attachment can be accomplished by a variety of means including screws, snap fittings, brackets and other suitable attachment means. Once support structure 11 is installed, all that generally is left for the refrigerator manufacturer is to attach inlet 12 to refrigerator water supply 13 and outlets 22a, 22b to the points of use. Replaceable components such as the filter element 16 and the like can be attached by the refrigerator manufacturer or the end user.

In actual use, water flows into the water filter assembly 10 through inlet 12. Water flows into storage means 14 where it may be prechilled prior to filtration and use. When either solenoid valve 21a or 21b opens based upon an input from the points of use, water begins flowing from storage means 14 and into filter element 16. Once filtered, the water exits the filter element 16 and passes over the flow sensor 18. The flow sensor 18 may be a paddle wheel, a turbine, a gear pump or any other suitable configuration to measure totality of water usage and/or flow rate. The sensor 18 is in communication with electronic unit 19 for receiving an output from the sensor 18. The electronics unit 19 can then transmit an output to display device 23 for alerting a user of current status and any actions that are required, such as changing the filter element 16. The filtered water then flows into the distribution manifold 20 and to point of use through outlet 22a or 22b.

While various embodiments of the present invention have been disclosed, it will be obvious to one skilled in the art that these embodiments are readily combinable and numerous water filter assembly embodiments are achievable.

What is claimed is:

1. A filtration system comprising a manifold, a filter attached to the manifold and a control unit that disables the filtration system if a selected criterion is outside of acceptable levels.

2. The filtration system of claim 1 wherein the manifold has a single outlet.

3. The filtration system of claim 1 wherein the manifold has two outlets with a valve controlling flow from the two outlets.

4. The filtration system of claim 1 further comprising a bar code reader and wherein the filter comprises a bar code that is positioned for evaluation by the bar code reader when the filter is attached to the manifold.

5. The filtration system of claim 4 wherein the bar code conveys information about the date of manufacture and wherein the selected criterion is the date of manufacture.

6. The filtration system of claim 4 wherein the bar code conveys information about the flow capacity and wherein the selected criterion is the total flow and the acceptable level is the flow capacity from the bar code.

7. The filtration system of claim 1 further comprising a flow sensor and wherein the control unit monitors total flow through a valve.

8. The filtration system of claim 1 wherein the filter is sealed within a cartridge that is rotatably connected to or slidably connected with the manifold.

9. The filtration system of claim 1 further comprising a support structure wherein the manifold, filter and control unit are connected to the support structure as a self-contained unit.

10. An appliance comprising and the filtration system of claim 1 connected to a water supply.

11. The applicant of claim 10 wherein the appliance is a refrigerator.

12. A method for controlling a water filtration system, the method comprising disabling the filtration system if a selected criterion is outside of acceptable levels.

13. The method of claim 12 wherein the selected criterion is the date of manufacture.

14. The method of claim 12 wherein the selected criterion is the total flow through the filter.

15. The method of claim 12 further comprising sensing a bar code on a filter element using a bar code reader.

16. The method of claim 12 further comprising evaluating total flow through a filter using a flow sensor.

17. The method of claim 12 further comprising evaluating conductivity of filtered water.

18. The method of claim 12 wherein the water filtration system comprises a filter cartridge releasably connected to a manifold.

19. A method for evaluating a filter cartridge attached to a filtration system comprising a control unit, the method comprising using the control unit of the filtration system to evaluate filter life based on the manufacture date.

20. The method of claim 19 further comprising reading the manufacture date from a bar code on the filter using a bar code reader.

21. The method of claim 19 further comprising disabling the filtration system if the manufacture date is outside of acceptable ranges.

22. The method of claim 19 wherein the filter cartridge comprises a filter medium sealed within the filter cartridge.

23. The method of claim 22 wherein the filter cartridge is releasably connected to a manifold with the connection and release of the filter with the manifold induced by rotational motion of the filter cartridge.

24. A filtration system comprising a sensor, a manifold, and a replaceable filter element connected of the manifold, wherein the filter element comprises a bar code indicating the date of manufacture and wherein the sensor reads the bar code to give the date of manufacture from the filter.

25. The filtration system of claim 24 further comprising a control unit and a display.

26. The filtration system of claim 25 wherein the display shows the status of the system and wherein the status is based on the date of manufacture of the filter.

27. The filtration system of claim 24 wherein filter element is releasably connected to the manifold through a rotational connection or a slidable connection.

28. An appliance comprising the filtration system of claim 24 connected to a water supply.

29. The appliance of claim 29 wherein the appliance is a refrigerator.
